(19) United States
(12) Patent Application Publication
(10) Pub. No.: US 2005/0271804 A1
(43) Pub. Date: Dec. 8, 2005

(54) Manufacturing method of color filter film and image sensor device

(76) Inventors: Hsin-Wei Lin, Hsinchu (TW); En-Ting Liu, Hsinchu (TW); Der-Yu Chou, Hsinchu (TW); Wang-Hsiang Ho, Hsinchu (TW); Chen-Hung Liao, Hsinchu (TW)

Correspondence Address: J C PATENTS, INC., 4 VENTURE, SUITE 250, IRVINE, CA, 92618, US

(21) Appl. No.: 10/863,318

(22) Filed: Jun. 7, 2004

(51) Int. Cl. B05D 5/06

(52) U.S. Cl. 427/164

(57) ABSTRACT

A manufacturing method of a color filter film and an image sensor device is provided. The manufacturing method of the color filter film, comprises forming a color filter material layer over a substrate. Then, a segregation layer is formed over the color filter material layer to reduce a component of the color filter material layer from escaping. Thereafter, a patterning process is performed over the color filter material layer to form a color filter pattern, wherein a segregation layer is removed during the patterning process. Accordingly, since a segregation layer is formed over the color filter material layer before the patterning process is performed, the problem of contamination of the apparatus due to the escape of the component of the color filter material layer during the patterning process is reduced.

### BACKGROUND OF THE INVENTION

1. Field of the Invention

The present invention relates to a manufacturing method of a thin film and a corresponding component of the thin film. More specifically, the present invention relates to a manufacturing method of a color filter film and a manufacturing method of an image sensor device corresponding to the color filter film.

2. Description of the Related Art

In recent years, a variety of image display devices provide colored images due to the development of semiconductor and electronic technologies. Therefore, color filter films for colors such as the three primary colors red, green, and blue are necessary and important components of an image display device. Generally in order to form a color filter film first, a color filter material layer is formed on a substrate. Next, the color filter material layer is exposed and developed by performing a patterning process in order to form a color filter pattern. The patterning process is repeated at least thrice to form three color filter films, which together construct the three colors of the color filter pattern.

When the color filter material layer is exposed, some chemical materials of the color filter material layer are vaporized. Hence, the lens of the stepper is contaminated by the vaporized chemical materials. Thus, it becomes necessary to clean the lens of the stepper regularly in order to avoid the contamination of the lens. This is because, if the lens is not cleaned regularly, the chemical materials contaminating the lens will influence the usage of the stepper. However, regular cleaning of the lens is a complex and time consuming process. Moreover, this reduces the yield rate of the image display device and increases the cost.

Also when the lens is contaminated by the chemical materials, an unexpected and abnormal reflection or refraction of incident light occurs when the exposure step is performed. This may cause the exposure of the portions of the color filter material layer that should not be exposed. Thus, the precision of the patterning of the color filter material layer is reduced. In addition, the contamination caused by the chemical materials influences the yield of the image display device.

### SUMMARY OF THE INVENTION

Therefore, the present invention is directed to a manufacturing method of a color filter film with a view of reducing the contamination of the color filter film apparatus during the patterning process.

In addition, the present invention is directed to a manufacturing method of an image sensor device with a view of reducing the contamination of the image sensor device apparatus during the patterning process performed.

The manufacturing method of the color filter film described according to an embodiment of the present invention comprises the following steps. First, a color filter material layer is formed over a substrate. Then, a segregation layer is formed over the color filter material layer in order to reduce a component of the color filter material layer from escaping. Thereafter, a patterning process is performed over the color filter material layer to form a color filter pattern, wherein the segregation layer is removed during the patterning process.

In another embodiment of the invention, the manufacturing method of an image sensor device described in the present invention comprises the following steps. First, a substrate comprising a plurality of sensor cells is provided. Next, a first color filter material layer is formed over the substrate. Thereafter, a first segregation layer is formed over the first color filter material layer for reducing a component of the first color filter material layer from escaping. Then, a first patterning process is performed over the first color filter material layer to form a first color filter pattern, wherein the first segregation layer is removed during the first patterning process. Next, a second color filter material layer is formed over the substrate. Thereafter, a second segregation layer is formed over the second color filter material layer for reducing a component of the second color filter material layer from escaping. Next, a second patterning process is performed over the second color filter material layer to form a second color filter pattern, wherein the second segregation layer is removed during the second patterning process. Next, a third color filter material layer is formed over the substrate. A third segregation layer is formed over the third color filter material layer for reducing a component of the third color filter material layer from escaping. Then, a third patterning process is performed over the third color filter material layer to form a third color filter pattern, wherein the third segregation layer is removed during the third patterning process. A color filter film constitutes the first color filter pattern, the second color filter pattern and the third color filter pattern.

Accordingly, in the present invention, a segregation layer is formed over the color filter material layer before performing the patterning process over the color filter material layer. Therefore, the problem of contamination of the apparatus due to the escaped component of the color filter material layer during the patterning process is reduced.

It is to be understood that both the foregoing general description and the following detailed description are exemplary, and are intended to provide further explanation of the invention as claimed.

### BRIEF DESCRIPTION OF THE DRAWINGS

The accompanying drawings are intended to provide further understanding of the invention, and are incorporated in and constitute a part of this specification. The drawings illustrate embodiments of the invention and, together with the description, serve to explain the principles of the invention.

FIG. 1A to FIG. 1D are schematic cross-sectional views illustrating the different stages in the manufacturing process of an image sensor device according to one embodiment of the present invention.

### DESCRIPTION OF THE EMBODIMENTS

The present invention is described in detail hereinafter with reference to the accompanying drawings, in which preferred embodiments of the invention are illustrated. The present invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

In the embodiment hereinafter, although only some manufacturing methods of an image sensor device of the present invention are illustrated and described, however, the scope of the present invention is not limited to the embodiments described herein. The manufacturing method of the present invention and the device thereof are applicable to any component or product requiring a color filter film.

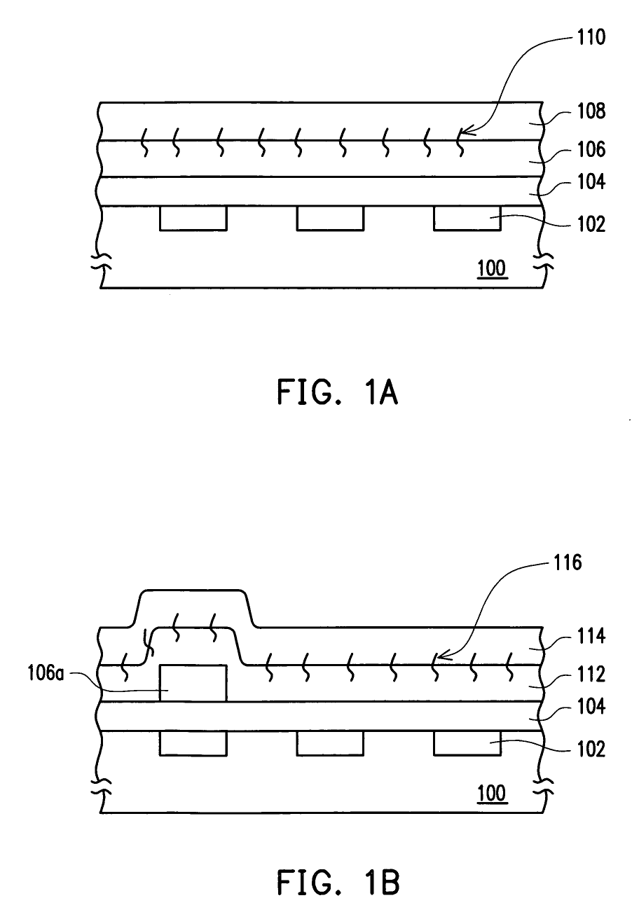

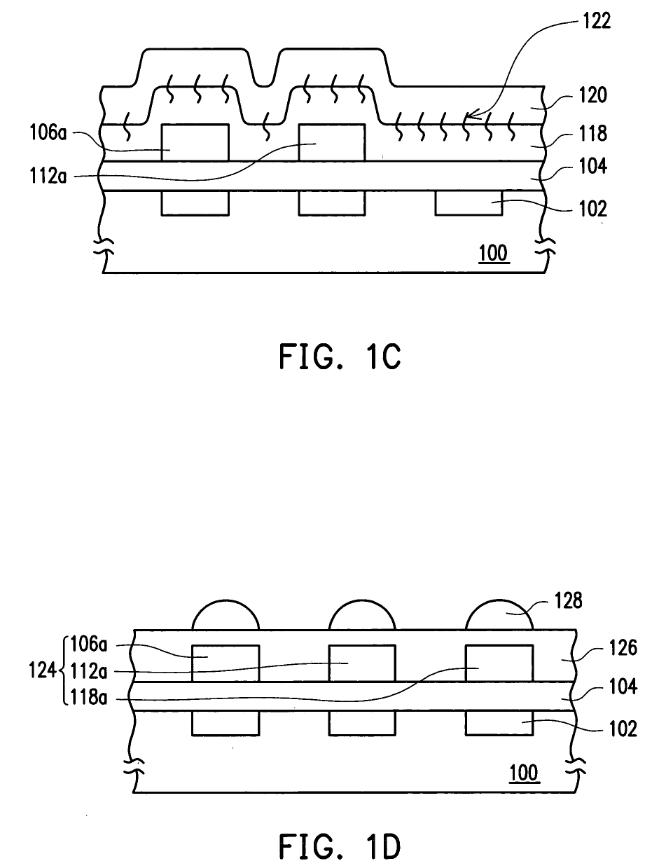

FIG. 1A to FIG. 1D are schematic cross-sectional views illustrating the different stages in the manufacturing process of an image sensor device, according to one embodiment of the present invention.

Referring to FIG. 1A, the manufacturing method of the image sensor device of the present invention comprises the following steps described herein. First, a substrate 100 comprising a plurality of sensor cells 102 is provided. The sensor cells 102 comprise, a sensor component is adapted for converting light into current signals and reading the signals using a driving circuit, such as a light diode sensor or other applicable light sensor unit. Therefore, when light is incident on the sensor cells 102 via micro-lenses (not shown in figure), the light is converted to a current signal and is read by the driving circuit.

Thereafter, a color filter material layer 106 is formed over the substrate 100. The color of the color filter material layer 106 comprises, for example, but not limited to, red (R), green (G) or blue (B). In addition, the color filter material layer 106 is made of a material such as a light sensing material or a material possessing photoresist characteristic. The structure of the color filter material layer 106 is strengthened or damaged by an exposure step which is describe in the following sections. The color filter pattern (not shown in figure) is formed after the development step.

Furthermore, in one embodiment of the present invention, before the color filter material layer 106 is formed, a protection layer 104 as shown in FIG. 1A is formed over the substrate 100 to cover the sensor cells 102 of the substrate 100. The protection layer 104 is made of a material comprising, for example but not limited to, silicon oxide, silicon nitride or other applicable material. Also, according to one embodiment of the present invention, chemical vapor deposition (CVD) process may be used for forming the protection layer 104.

Thereafter, a segregation layer 108 is formed over the color filter material layer 106 to prevent a component 110 of the color filter material layer 106 from escaping. In accordance with one embodiment of the present invention, the segregation layer 108 is made of, for example but nit limited to, a material such as, hexamethyl disiloxane (HMDSO) or a material that can prevent the component 110 of the color filter material layer 106 from escaping to an external reaction chamber. Also, according to one embodiment of the present invention, a coating process is used for forming the segregation layer 108. The escape of the component 110 of the color filter material layer 106 to the reaction chamber occurs due to chemical reactions such as, decomposition, vaporization or evaporation. The escaped component 110 comprises, the color filter material layer itself, the byproduct generated from the chemical reaction of the color filter material layer 106 with other materials or a chemical material such as a solvent. According to one embodiment of the present invention the segregation layer 108 absorbs, decomposes or covers the escaped component of the color filter material layer 106 in order to reduce the component 110 from escaping to the reaction chamber. Therefore, contamination of the reaction chamber or the apparatus due to the escaped component 110 is reduced. Thus the segregation layer 108 comprises, an absorption layer, a decomposition layer or a cover layer. Furthermore, in another embodiment of the present invention, the segregation layer 108 is also anti-reflective layer or comprises an anti-reflective coating layer. Therefore, when the following exposure step is performed, reduction of the precision of exposure due to unexpected or abnormal reflection or refraction of light is improved.

Thereafter, referring to FIG. 1B, a first patterning process is performed over the color filter material layer 106 to form a color filter pattern 106a. According to one embodiment of the present invention, the patterning process comprises an exposure step and a development step and will be described hereinafter.

After the segregation layer 108 is formed, an exposure step is performed using the color filter material layer 106. According to one embodiment of the present invention, the exposure step is performed using a stepper to expose the substrate 100. The color filter material layer 106 is covered by a segregation layer 108 in order to reduce a component 110 of the color filter material layer 106 from escaping, wherein the exposure step is not influenced by the segregation layer 108. Therefore, the lens of the stepper or the other apparatus is not contaminated by the escaped component 110 of the color filter material layer 106 and hence, the problem of regularly cleaning it to reduce contamination is resolved. The cost and the process time are reduced and the yield is enhanced.

Next, the development step is performed and a color filter pattern 106a as illustrated in FIG. 1B is obtained. It is noted that when the development step is performed, the segregation layer 108 is also removed as it dissolves during the development step.

Next, a second color filter pattern is formed over the substrate 100. The patterning process of the second color filter is similar to the patterning process of the color filter pattern 106a described in the preceding section except that the color of the second color filter is different from that of the first color filter. Therefore, in another embodiment of the present invention, the material and the process parameters used in the patterning process of the second color filter are the same as those used in the patterning process of the first color filter. The patterning process of the second color filter is described in the following sections.

Referring to FIG. 1B, a color filter material layer 112 having a different color than the color filter pattern 106a is formed over the substrate 100. Then, a segregation layer 114 is formed over the color filter material layer 112 to reduce a component 116 of the color filter material layer 112 from escaping. According to one embodiment of the present invention, the segregation layer 114 is composed of a material such as, hexamethyl disiloxane (HMDSO) or any other material that can reduce the component 116 of the color filter material layer 112 from escaping. Also, according to one embodiment of the present invention, coating process is used to form the segregation layer 114.

Thereafter, referring to FIG. 1C, a patterning process is performed over the color filter material layer 112 to form a color filter pattern 112a. The patterning process comprises an exposure step and a development step. When the exposure step is performed, the color filter material layer 112 is covered with a segregation layer 114 in order to reduce a component 116 of the color filter material layer 112 from escaping, wherein the exposure step is not influenced by the segregation layer 114. Therefore, the lens of the stepper or the other apparatus is not contaminated by the escaped component 116 of the color filter material layer 112 and hence, the problem of regularly cleaning it to prevent contamination is resolved. The cost and the process time are reduced and the yield is enhanced. In addition, when the development step is performed, the segregation layer 114 is also removed as it dissolves during the development step.

Next, a third color filter pattern is formed over the substrate 100. The patterning process of the third color filter is similar to the patterning process of the color filter pattern 106a and 112a described in the preceding section except that the color of the third color filter is different from that of the first and the second color filter. Therefore, in another embodiment of the present invention, the material and the process parameters used in the patterning process of the third color filter are the same as those used in the patterning process of the first and the second color filter. The patterning process of the third color filter is described in the following sections.

Referring to FIG. 1C, a color filter material layer 118 having a different color than the color filter patterns 106a and 112a is formed over the substrate 100. Next, a segregation layer 120 is formed over the color filter material layer 118 to prevent a component 122 of the color filter material layer 118 from escaping. According to one embodiment of the present invention, the segregation layer 120 comprises, for example but not limited to, hexamethyl disiloxane (HMDSO) or any other material that can prevent the component 122 of the color filter material layer 118 from escaping to the reaction chamber. Also, according to one embodiment of the present invention, a coating process may be used to form the segregation layer 120.

Thereafter, referring to FIG. 1D, a patterning process is performed over the color filter material layer 118 to form a color filter pattern 118a. Hence, a color filter film 124 is constructed by the color filter patterns 106a, 112a and 118a. The patterning process comprises an exposure step and a development step. When the exposure step is performed, the color filter material layer 118 is covered with a segregation layer 120 to prevent a component 122 of the color filter material layer 118 from escaping, wherein the exposure step is not influenced by the segregation layer 120. Therefore, the contamination of the lens of the stepper or the other apparatus by the escaped component 122 of the color filter material layer 118 is effectively prevented and hence, the problem of regularly cleaning the lens of the stepper or other apparatus to remove the contamination is prevented. Thus, the cost and the process time are reduced and the yield is enhanced. In addition, when the development step is performed, the segregation layer 120 is also removed as it dissolves during the development step.

Furthermore, in one embodiment of the present invention, after the color filter film 124 is formed, a plurality of micro-lenses 128 corresponding to each color filter pattern 106a, 112a and 118a are formed over the color filter film 124 as illustrated in FIG. 1D. Thus, the incident light is focused by the micro-lenses 128 and projected to the sensor cells 102 to be converted into a current signal. Next, the current signal is read by the driving circuit. According to one embodiment of the present invention, the micro-lens 128 is composed of for example but not limited to, a highly transparent photoresist material. Also, according to one embodiment of the present invention the method of forming the micro-lens 128 over the color filter film 124 comprises, for example but not limited to, the following steps. First, the photoresist material layer (or called the micro-lens material layer) is coated over the color filter film 124, and then a segregation layer is formed over the photoresist material layer to prevent the escape of the component of the photoresist material layer. The material and the forming method of the segregation layer is same as or similar to that of the segregation layers 108, 114 or 120, and thus will no more be described. Next, a patterning process comprising an exposure step and a development step is performed in order to form a plurality of discrete photoresist patterns, wherein the segregation layer is removed during the patterning process. Thereafter, a thermal process is performed so as to smoothen the corner of the photoresist pattern to form a plurality of micro-lenses 128 for focusing the incident light.

Moreover, according to one embodiment of the invention, after the color filter film 124 is formed and before the micro-lenses 128 are formed, a flat layer 126 is formed over the color filter film 124. Only after forming the flat layer 126, the micro-lenses 128 corresponding to the color filter pattern 106a, 112a and 118a are formed. Also in accordance with one embodiment of the present invention, the flat layer 126 is composed of, for example but not limited to, a transparent material such as a material that is formed by the polymerization of transparent polymer or other applicable material. The flat layer 126 is formed by, for example but not limited to, forming a flat material layer (not shown) over the color filter film 124 by, for example, a coating method. Then a segregation layer is formed over the flat material layer to prevent the escape of the component of the flat layer 126. The material and the forming method of the segregation layer is same as or similar to that of the segregation layers 108, 114 or 120, and thus will no more be described. Next, a patterning process comprising an exposure step and a development step is performed to form the flat layer 126, wherein the segregation layer is removed during the patterning process.

Hence, the present invention has at least the following advantages. According to one embodiment of the present invention, a segregation layer is formed over the color filter material layer, the flat material layer or the photoresist material layer (the micro-lens material layer) before the patterning process is performed. Therefore, the contamination of the lens of the stepper or the other apparatus by the escaped component of these materials layer described above is effectively prevented and hence, the problem of regularly cleaning it to prevent the contamination is resolved. The cost and the process time are reduced and the yield is enhanced.

In the embodiments of the present invention described above, although only some manufacturing methods of an image sensor device of the present invention are illustrated and described, however, the scope of the present invention is not limited to the embodiments described herein. The manufacturing method of the present invention and the device thereof are applicable to any component or product requiring a color filter film. It is noted that in the manufacturing process of the color filter film described in the present invention, before the patterning process of the color filter material layer is performed, the color filter material layer is covered by a segregation layer in order to effectively prevent a component of the color filter material layer from escaping during the patterning process. Therefore, the method of the present invention can be adopted in any component or product that comprises a color filter film such as a liquid crystal display (LCD), in order to solve the problem of contamination of the stepper lens or other apparatus due to the escaped component of color filter material layer.

It will be apparent to those skilled in the art that various modifications and variations can be made to the structure of the present invention without changing the scope or departing from the spirit of the present invention. In view of the foregoing, it is intended that the present invention cover modifications and variations of this invention provided they fall within the scope of the following claims and their equivalents.

1. A method of manufacturing a color filter film, comprising:
forming a color filter material layer over a substrate;
forming a segregation layer over the color filter material layer to prevent a component of the color filter material layer from escaping; and
performing a patterning process over the color filter material layer to form a color filter pattern, wherein the segregation layer is removed during the patterning process.

2. The method of claim 1, wherein the segregation layer is formed using a coating process.

3. The method of claim 1, wherein the segregation layer is an absorption layer capable of absorbing an escaped component of the color filter material layer.

4. The method of claim 3, wherein the segregation layer comprises an anti-reflective coating layer.

5. The method of claim 4, wherein the segregation layer comprises hexamethyl disiloxane (HMDSO).

6. The method of claim 1, wherein the color filter material layer comprises a photoresist material.

7. The method of claim 1, wherein the patterning process comprises:
performing an exposure step; and
performing a development step, wherein the segregation layer is removed during the development step.

8. A method of manufacturing an image sensor device, comprising the steps of:
providing a substrate comprising a plurality of sensor cells formed thereon;
forming a first color filter material layer over the substrate;
forming a first segregation layer over the first color filter material layer to prevent a component of the first color filter material layer from escaping;
performing a first patterning process over the first color filter material layer to form a first color filter pattern, wherein the first segregation layer is removed during the first patterning process;
forming a second color filter material layer over the substrate;
forming a second segregation layer over the second color filter material layer to prevent a component of the second color filter material layer from escaping;
performing a second patterning process over the second color filter material layer to form a second color filter pattern, wherein the second segregation layer is removed during the second patterning process;
forming a third color filter material layer over the substrate;
forming a third segregation layer over the third color filter material layer to prevent a component of the third color filter material layer from escaping; and
performing a third patterning process over the third color filter material layer to form a third color filter pattern, wherein the third segregation layer is removed during the third patterning process, wherein a color filter film constitutes the first color filter pattern, the second color filter pattern and the third color filter pattern.

9. The method of claim 8, wherein at least one of the first segregation layer, the second segregation layer and the third segregation layer is formed using a coating process.

10. The method of claim 8, wherein at least one of the first segregation layer, the second segregation layer and the third segregation layer comprises an absorption layer capable of absorbing an escaped component of the first color filter material layer, the second color filter material layer and the third color filter material layer.

11. The method of claim 10, wherein at least one of the first segregation layer, the second segregation layer and the third segregation layer comprises an anti-reflective coating layer.

12. The method of claim 11, at least one of the first segregation layer, the second segregation layer and the third segregation layer comprises hexamethyl disiloxane (HMDSO).

13. The method of claim 8, wherein at least one of the first color filter material layer, the second color filter material layer and the third color filter material layer comprises a photoresist material.

14. The method of claim 8, wherein at least one of the process from among the first patterning process, the second patterning process and the third patterning process comprises:
performing an exposure step; and
performing a development step, wherein at least one of the first segregation layer, the second segregation layer and the third segregation layer is removed during the development step.

15. The method of claim 8, wherein a protection layer is formed over the sensor cells on the substrate.

16. The method of claim 8, further comprising a step of forming a plurality of micro-lenses over the color filter film is performed after the step of forming the color filter film.

17. The method of claim 16, wherein the step of forming the micro-lenses comprises:
forming a micro-lens material layer over the color filter film;
forming a segregation layer over the micro-lens material layer to prevent an escape of a component of the micro-lens material layer; and
performing a patterning process to form the micro-lenses, wherein the segregation layer is removed during the patterning process.

18. The method of claim 16, further comprising a step of forming a flat layer over the substrate to cover the color filter film is performed after the step of forming the color filter film but before the step of forming the micro-lenses, wherein the micro-lenses is formed over the flat layer.

19. The method of claim 18, wherein the step of forming the flat layer comprises:
forming a flat material layer over the substrate to cover the color filter film;
forming a segregation layer over the flat material layer to prevent an escape of a component of the flat layer; and
performing a patterning process to form the flat layers 126, wherein the segregation layer is removed during the patterning process.
